(19) United States
(12) Patent Application Publication
(10) Pub. No.: US 2023/0105891 A1
(43) Pub. Date: Apr. 6, 2023

(54) SIGN DETECTION DEVICE, DRIVING ASSISTANCE CONTROL DEVICE, AND SIGN DETECTION METHOD

(71) Applicant: Mitsubishi Electric Corporation, Tokyo (JP)

(72) Inventor: Gentaro WASHIO, Tokyo (JP)

(73) Assignee: Mitsubishi Electric Corporation, Tokyo (JP)

(21) Appl. No.: 17/796,045

(22) PCT Filed: Feb. 6, 2020
(86) PCT No.: PCT/JP2020/004459

§ 371 Date: Jul. 28, 2022

(51) Int. Cl. B60W 30/08; G06V 20/59; B60W 40/08; B60W 10/18; B60W 10/20

(52) U.S. Cl. CPC B60W 30/08; G06V 20/597; B60W 40/08; B60W 10/18; B60W 10/20; B60W 2040/0827; B60W 2420/42

(57) ABSTRACT

A sign detection device includes an information acquiring unit to acquire eye opening degree information indicating an eye opening degree of a driver in a mobile object, surrounding information indicating a surrounding state of the mobile object, and mobile object information indicating a state of the mobile object, and a sign detection unit to detect a sign of the driver dozing off by determining whether the eye opening degree satisfies a first condition based on a threshold and by determining whether a state of the mobile object satisfies a second condition corresponding to the surrounding state.

### TECHNICAL FIELD

The present disclosure relates to a sign detection device, a driving assistance control device, and a sign detection method.

### BACKGROUND ART

Conventionally, a technique of detecting an abnormal state of a driver by using an image captured by a camera for vehicle interior imaging has been developed. Specifically, for example, a technique for detecting a dozing state of a driver has been developed. Further, a technique for outputting a warning when an abnormal state of a driver is detected has been developed (see, for example, Patent Literature 1).

### CITATION LIST

### Patent Literature

Patent Literature 1: International Publication No. 2015/106690

### SUMMARY OF INVENTION

### Technical Problem

The warning against dozing is preferably output before the occurrence of the dozing state. That is, it is preferable that the warning against dozing is output at the timing when the sign of dozing occurs. However, the conventional technique detects an abnormal state including a dozing state, and does not detect a sign of dozing. For this reason, there is a problem that the warning against dozing cannot be output at the timing when the sign of dozing occurs.

The present disclosure has been made to solve the above problem, and an object thereof is to detect a sign of a driver dozing off.

### Solution to Problem

A sign detection device according to the present disclosure includes: an information acquiring unit to acquire eye opening degree information indicating an eye opening degree of a driver in a mobile object, surrounding information indicating a surrounding state of the mobile object, and mobile object information indicating a state of the mobile object; and a sign detection unit to detect a sign of the driver dozing off by determining whether the eye opening degree satisfies a first condition based on a threshold and by determining whether the state of the mobile object satisfies a second condition corresponding to the surrounding state.

### Advantageous Effects of Invention

According to the present disclosure, with the above configuration, it is possible to detect a sign of the driver dozing off.

### BRIEF DESCRIPTION OF DRAWINGS

FIG. 1 is a block diagram illustrating a main part of a driving assistance control device including a sign detection device according to a first embodiment.

FIG. 2 is a block diagram illustrating a hardware configuration of a main part of the driving assistance control device including the sign detection device according to the first embodiment.

FIG. 3 is a block diagram illustrating another hardware configuration of the main part of the driving assistance control device including the sign detection device according to the first embodiment.

FIG. 4 is a block diagram illustrating another hardware configuration of the main part of the driving assistance control device including the sign detection device according to the first embodiment.

FIG. 5 is a flowchart illustrating an operation of the driving assistance control device including the sign detection device according to the first embodiment.

FIG. 6 is a flowchart illustrating an operation of a sign detection unit in the sign detection device according to the first embodiment.

FIG. 7A is a flowchart illustrating an operation of a second determination unit of the sign detection unit in the sign detection device according to the first embodiment.

FIG. 7B is a flowchart illustrating an operation of the second determination unit of the sign detection unit in the sign detection device according to the first embodiment.

FIG. 8 is a block diagram illustrating a system configuration of a main part of the driving assistance control device including the sign detection device according to the first embodiment.

FIG. 9 is a block diagram illustrating another system configuration of the main part of the driving assistance control device including the sign detection device according to the first embodiment.

FIG. 10 is a block diagram illustrating another system configuration of the main part of the driving assistance control device including the sign detection device according to the first embodiment.

FIG. 11 is a block diagram illustrating another system configuration of the main part of the driving assistance control device including the sign detection device according to the first embodiment.

FIG. 12 is a block diagram illustrating another system configuration of the main part of the driving assistance control device including the sign detection device according to the first embodiment.

FIG. 13 is a block diagram illustrating another system configuration of the main part of the driving assistance control device including the sign detection device according to the first embodiment.

FIG. 14 is a block diagram illustrating a system configuration of a main part of the sign detection device according to the first embodiment.

FIG. 15 is a block diagram illustrating a main part of a driving assistance control device including a sign detection device according to a second embodiment.

FIG. 16 is a block diagram illustrating a main part of a learning device for the sign detection device according to the second embodiment.

FIG. 17 is a block diagram illustrating a hardware configuration of a main part of the learning device for the sign detection device according to the second embodiment.

FIG. 18 is a block diagram illustrating another hardware configuration of the main part of the learning device for the sign detection device according to the second embodiment.

FIG. 19 is a block diagram illustrating another hardware configuration of the main part of the learning device for the sign detection device according to the second embodiment.

FIG. 20 is a flowchart illustrating an operation of the driving assistance control device including the sign detection device according to the second embodiment.

FIG. 21 is a flowchart illustrating an operation of the learning device for the sign detection device according to the second embodiment.

### DESCRIPTION OF EMBODIMENTS

In order to explain this disclosure in more detail, a mode for carrying out the present disclosure will be described below with reference to the accompanying drawings.

### First Embodiment

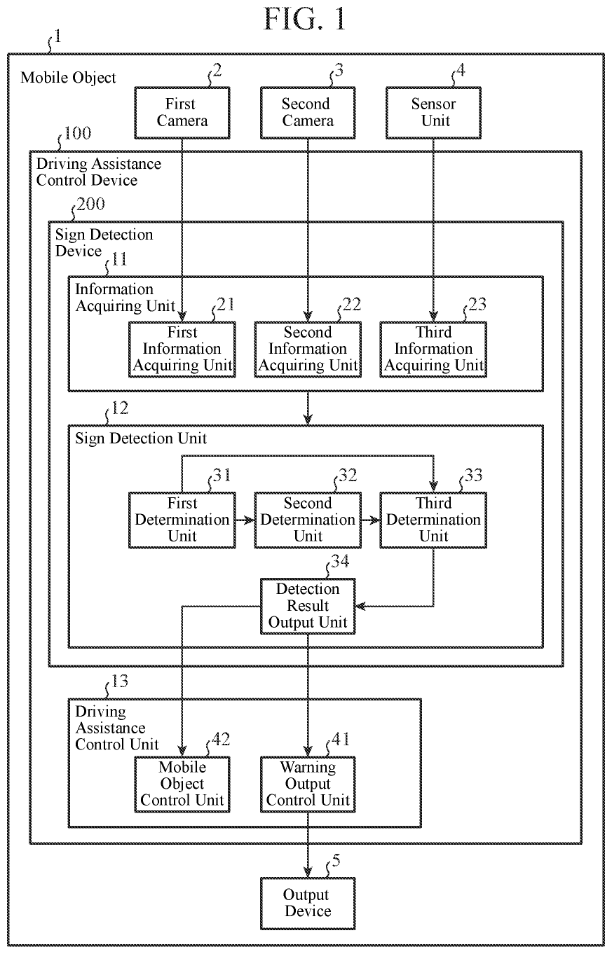

FIG. 1 is a block diagram illustrating a main part of a driving assistance control device including a sign detection device according to a first embodiment. The driving assistance control device including the sign detection device according to the first embodiment will be described with reference to FIG. 1.

As illustrated in FIG. 1, a mobile object 1 includes a first camera 2, a second camera 3, a sensor unit 4, and an output device 5.

The mobile object 1 includes any mobile object. Specifically, for example, the mobile object 1 is configured by a vehicle, a ship, or an aircraft. Hereinafter, an example in which the mobile object 1 is configured by a vehicle will be mainly described. Hereinafter, such a vehicle may he referred to as a “host vehicle”. In addition, a vehicle different from the host vehicle may be referred to as “another vehicle”.

The first camera 2 is configured by a camera for vehicle interior imaging and is configured by a camera for moving image imaging. Hereinafter, each of still images constituting a moving image captured by the first camera 2 may be referred to as a “first captured image”. The first camera 2 is provided, for example, on the dashboard of the host vehicle. The range imaged by the first camera 2 includes the driver's seat of the host vehicle. Therefore, when the driver is seated on the driver's seat in the host vehicle, the first captured image can include the face of the driver.

The second camera 3 is configured by a camera for vehicle outside imaging, and is configured by a camera for moving image imaging. Hereinafter, each of still images constituting a moving image captured by the second camera 3 may be referred to as a “second captured image”. The range imaged by the second camera 3 includes an area ahead of the host vehicle (hereinafter referred to as a “forward area”). Therefore, when a white line is drawn on the road in the forward area, the second captured image can include such a white line. In addition, when an obstacle (for example, another vehicle or a pedestrian) is present in the forward area, the second captured image can include such an obstacle. Furthermore, when a traffic light is installed in the forward area, the second captured image can include such a traffic light.

The sensor unit 4 includes a plurality of types of sensors. Specifically, for example, the sensor unit 4 includes a sensor that detects a traveling speed of the host vehicle, a sensor that detects a shift position in the host vehicle, a sensor that detects a steering angle in the host vehicle, and a sensor that detects a throttle opening in the host vehicle. Further, for example, the sensor unit 4 includes a sensor that detects an operation amount of an accelerator pedal in the host vehicle and a sensor that detects an operation amount of a brake pedal in the host vehicle.

The output device 5 includes at least one of a display, a speaker, a vibrator, and a wireless communication device. The display includes, for example, a liquid crystal display, an organic electro-luminescence (EL) display, or a head-up display (HUD). The display is provided, for example, on the dashboard of the host vehicle. The speaker is provided, for example, on the dashboard of the host vehicle. The vibrator is provided, for example, at the steering wheel of the host vehicle or the driver's seat of the host vehicle. The wireless communication device includes a transmitter and a receiver.

As illustrated in FIG. 1, the mobile object 1 has a driving assistance control device 100. The driving assistance control device 100 includes an information acquiring unit 11, a sign detection unit 12, and a driving assistance control unit 13. The information acquiring unit 11 includes a first information acquiring unit 21, a second information acquiring unit 22, and a third information acquiring unit 23. The sign detection unit 12 includes a first determination unit 31, a second determination unit 32, a third determination unit 33, and a detection result output unit 34. The driving assistance control unit 13 includes a warning output control unit 41 and a mobile object control unit 42. The information acquiring unit 11 and the sign detection unit 12 constitute a main part of a sign detection device 200.

The first information acquiring unit 21 acquires information indicating the state of the driver (hereinafter, referred to as “driver information”) of the mobile object 1 by using the first camera 2. The driver information includes, for example, information indicating a face direction of the driver (hereinafter, referred to as “face direction information”), information indicating a line-of-sight direction of the driver (hereinafter, referred to as “line-of-sight information”), and information indicating an eye opening degree D of the driver (hereinafter, referred to as “eye opening degree information”).

That is, for example, the first information acquiring unit 21 estimates the face direction of the driver by executing image processing for face direction estimation on the first captured image. As a result, the face direction information is acquired. Various known techniques can be used for such image processing. Detailed description of these techniques will be omitted.

Furthermore, for example, the first information acquiring unit 21 detects the line-of-sight direction of the driver by executing image processing for line-of-sight detection on the first captured image. Thus, the fine-of-sight information is acquired. Various known techniques can be used for such image processing. Detailed description of these techniques will be omitted.

Furthermore, for example, the first information acquiring unit 21 calculates the eye opening degree D of the driver by executing image processing for eye opening degree calculation on the first captured image. Thus, the eye opening degree information is acquired. Various known techniques can be used for such image processing. Detailed description of these techniques will be omitted.

Here, the “eye opening degree” is a value indicating an opening degree of a human eye. The eye opening degree is calculated to a value within a range of 0 to 100%. The eye opening degree is calculated by measuring characteristics (distance between lower eyelid and upper eyelid, shape of upper eyelid, shape of iris, and the like) in an image including human eyes. As a result, the eve opening degree becomes a value indicating an opening degree of the eye without being affected by individual differences.

The second information acquiring unit 22 acquires information (hereinafter, referred to as “surrounding information” indicating a surrounding state of the mobile object 1 using the second camera 3. The surrounding information includes, for example, information indicating a white line (hereinafter, referred to as “white line information”) when the white line has been drawn on a road in the forward area. In addition, the surrounding information includes, for example, information indicating an obstacle (hereinafter, referred to as “obstacle information”) when the obstacle is present in the forward area. In addition, the surrounding information includes, for example, information indicating that a brake lamp of another vehicle in the forward area is lit (hereinafter, referred to as “brake lamp information”). In addition, the surrounding information includes, for example, information indicating that a traffic light in the forward area is lit in red (hereinafter, referred to as “red light information”).

That is, for example, the second information acquiring unit 22 detects a white line drawn on a road in the forward area by executing image recognition processing on the second captured image. As a result, the white line information is acquired. Various known techniques can be used for such image recognition processing. Detailed description of these techniques will be omitted.

Furthermore, for example, the second information acquiring unit 22 detects an obstacle in the forward area by executing image recognition processing on the second captured image. As a result, the obstacle information is acquired. Various known techniques can be used for such image recognition processing. Detailed description of these techniques will be omitted.

Furthermore, for example, the second information acquiring unit 22 detects another vehicle in the forward area and determines whether or not the brake lamp of the detected other vehicle is lit by executing image recognition processing on the second captured image. As a result, the brake lamp information is acquired. Various known techniques can be used for such image recognition processing. Detailed description of these techniques will be omitted.

In addition, for example, the second information acquiring unit 22 detects a traffic light in the forward area and determines whether or not the detected traffic light is lit in red by executing image recognition processing on the second captured image. As a result, the red light information is acquired. Various known techniques can be used for such image recognition processing. Detailed description of these techniques will be omitted.

The third information acquiring unit 23 acquires information indicating a state of the mobile object 1 (hereinafter, referred to as “mobile object information”) using the sensor unit 4. More specifically, the mobile object information indicates a state of the mobile object corresponding to an operation by the driver. In other words, the mobile object information indicates a state of operation of the mobile object 1 by the driver. The mobile object information includes, for example, information indicating a state of accelerator operation (hereinafter, referred to as “accelerator operation information”) in the mobile object 1, information indicating a state of brake operation (hereinafter, referred to as “brake operation information”) in the mobile object 1, and information indicating a state of steering wheel operation (hereinafter, referred to as “steering wheel operation information”) in the mobile object 1.

That is, for example, the third information acquiring unit 23 detects the presence or absence of the accelerator operation by the driver of the host vehicle and detects the operation amount and the operation direction in the accelerator operation using the sensor unit 4. Thus, the accelerator operation information is acquired. For such detection, a sensor that detects a traveling speed of the host vehicle, a sensor that detects a shift position in the host vehicle, a sensor that detects a throttle opening in the host vehicle, a sensor that detects an operation amount of an accelerator pedal in the host vehicle, and the like are used.

For example, the third information acquiring unit 23 detects the presence or absence of the brake operation by the driver of the host vehicle and detects an operation amount and an operation direction in the brake operation, by using the sensor unit 4. Thus, the brake operation information is acquired. For such detection, a sensor that detects a traveling speed of the host vehicle, a sensor that detects a shift position in the host vehicle, a sensor that detects a throttle opening in the host vehicle, a sensor that detects an operation amount of a brake pedal in the host vehicle, and the like are used.

Further, for example, the third information acquiring unit 23 detects the presence or absence of the steering wheel operation by the driver of the host vehicle and detects an operation amount and an operation direction in the steering wheel operation, by using the sensor unit 4. Thus, the steering wheel operation information is acquired. For such detection, a sensor that detects a steering angle or the like in the host vehicle is used.

The first determination unit 31 detects whether or not the eye opening degree D satisfies a predetermined condition (hereinafter, referred to as a “first condition”) using the eye opening degree information acquired by the first information acquiring unit 21. Here, the first condition uses a predetermined threshold Dth.

Specifically, for example, the first condition is set to a condition that the eye opening degree D is below the threshold Dth. In this case, from the viewpoint of detecting the sign of dozing, the threshold Dth is not only set to a value smaller than 100%, but also preferably set to a value larger than 0%. Therefore, the threshold Dth is set to, for example, a value of 20% or more and less than 80%.

The second determination unit 32 determines whether or not the state of the mobile object 1 satisfies a predetermined condition (hereinafter, referred to as a “second condition”) using the surrounding information acquired by the second information acquiring unit 22 and the mobile object information acquired by the third information acquiring unit 23. Here, the second condition includes one or more conditions corresponding to the surrounding state of the mobile object 1.

Specifically, for example, the second condition includes a plurality of conditions as follows.

First, the second condition includes a condition that, when a white line of a road in the forward area is detected, a corresponding steering wheel operation is not performed within a predetermined time (hereinafter, referred to as “first reference time” or “reference time”) T1. That is, when the white line information is acquired by the second information acquiring unit 22, the second determination unit 32 determines whether or not an operation corresponding to the white line (for example, an operation of turning the steering wheel in a direction corresponding to the white line) is performed within the first reference time T1 by using the steering wheel operation information acquired by the third information acquiring unit 23. In a case where such an operation is not performed within the first reference time T1, the second determination unit 32 determines that the second condition is satisfied.

Second, the second condition includes a condition that, when an obstacle in the forward area is detected, the corresponding brake operation or steering wheel operation is not performed within a predetermined time (hereinafter, referred to as “second reference time” or “reference time”) T2. That is, when the obstacle information is acquired by the second information acquiring unit 22, the second determination unit 32 determines whether or not an operation corresponding to the obstacle (for example, an operation of decelerating the host vehicle, an operation of stopping the host vehicle, or an operation of turning the steering wheel in a direction of avoiding an obstacle) is performed within the second reference time T2 by using the brake operation information and the steering wheel operation information acquired by the third information acquiring unit 23. In a case where such an operation is not performed within the second reference time T2, the second determination unit 32 determines that the second condition is satisfied.

Third, the second condition includes a condition that, when lighting of a brake lamp of another vehicle in the forward area is detected, a corresponding brake operation is not performed within a predetermined time (hereinafter, referred to as “third reference time” or “reference time”) T3. That is, when the brake lamp information is acquired by the second information acquiring unit 22, the second determination unit 32 determines whether or not an operation corresponding to such lighting (for example, an operation of decelerating the host vehicle or an operation of stopping the host vehicle) is performed within the third reference time T3 by using the brake operation information acquired by the third information acquiring unit 23. In other words, the second determination unit 32 determines whether or not the operation is performed before the inter-vehicle distance between the host vehicle and the other vehicle becomes equal to or less than a predetermined distance. In a case where such an operation is not performed within the third reference time T3, the second determination unit 32 determines that the second condition is satisfied.

Fourth, the second condition includes a condition that, when lighting of a red light in the forward area is detected, the corresponding brake operation is not performed within a predetermined time (hereinafter, referred to as “fourth reference time” or “reference tune”) T4. That is, when the red light information is acquired by the second information acquiring unit 22, the second determination unit 32 determines whether or not an operation corresponding to such lighting (for example, an operation of decelerating the host vehicle or an operation of stopping the host vehicle) is performed within the fourth reference time T4 by using the brake operation information acquired by the third information acquiring unit 23, in a case where such an operation is not performed within the fourth reference time T4, the second determination unit 32 determines that the second condition is satisfied.

Note that the reference times T1, T2, T3, and T4 may be set to the same time, or may be set to different times.

The third determination unit 33 determines the presence or absence of a sign of the driver dozing off in the mobile object 1 on the basis of the determination result by the first determination unit 31 and the determination result by the second determination unit 32.

Specifically, for example, when the first determination unit 31 determines that the eye opening degree D satisfies the first condition, the second determination unit 32 determines whether or not the state of the mobile object 1 satisfies the second condition. On the other hand, when the first determination unit 31 determines that the eye opening degree D satisfies the first condition and the second determination unit 32 determines that the state of the mobile object 1 satisfies the second condition, the third determination unit 33 determines that there is a sign of the driver dozing off in the mobile object 1. With this determination, a sign of the driver dozing off in the mobile object 1 is detected. That is, the sign detection unit 12 detects a sign of the driver dozing off in the mobile object 1.

It is assumed that the presence or absence of the sign of dozing is determined on the basis of whether the eye opening degree D is a value less than the threshold Dth. In this case, when the driver of the mobile object 1 is drowsy due to drowsiness, the eye opening degree D is less than the threshold Dth, and it is conceivable that it is determined that there is a sign of dozing. However, in this case, when the driver of the mobile object 1 temporarily squints for some reason (for example, when the driver of the mobile object 1 temporarily squints due to feeling dazzled), there is a possibility that it is erroneously determined that there is a sign of dozing although there is no sign of dozing.

From the viewpoint of suppressing occurrence of such erroneous determination, the sign detection unit 12 includes a second determination unit 32 in addition to the first determination unit 31. That is, when the driver of the mobile object 1 is drowsy due to drowsiness, it is conceivable that there is a higher probability that the operation corresponding to the surrounding state is delayed than when the driver is not drowsy. In other words, it is conceivable that there is a high probability that such an operation is not performed within the reference time (T1, T2, T3, or T4). Therefore, the sign detection unit 12 suppresses the occurrence of erroneous determination as described above by using the determination result related to the eye opening degree D and the determination result related to the state of the operation on the mobile object 1 as an AND condition.

The detection result output unit 34 outputs a signal indicating a determination result by the third determination unit. That is, the detection result output unit 34 outputs a signal indicating a detection result by the sign detection unit 12. Hereinafter, such a signal is referred to as a “detection result signal”.

The warning output control unit 41 determines whether or not it is necessary to output a warning by using the detection result signal output by the detection result output unit 34. Specifically, for example, in a case where the detection result signal indicates the sign of dozing “present”, the warning output control unit 41 determines that it is necessary to output a warning. On the other hand, in a case where the detection result signal indicates the sign of dozing “absence”, the warning output control unit 41 determines that it is not necessary to output a warning.

In a case where it is determined that it is necessary to output a warning, the warning output control unit 41 executes control to output the warning (hereinafter, referred to as “warning output control”) using the output device 5. The warning output control includes at least one of control of displaying a warning image using a display, control of outputting warning sound using a speaker, control of vibrating a steering wheel of the mobile object 1 using a vibrator, control of vibrating a driver's seat of the mobile object 1 using a vibrator, control of transmitting a warning signal using a wireless communication device, and control of transmitting a warning electronic mail using a wireless communication device. The warning electronic mail is transmitted to, for example, the owner of the mobile object 1 or the supervisor of the driver of the mobile object 1.

The mobile object control unit 42 determines whether it is necessary to control the operation of the mobile object 1 (hereinafter, referred to as “mobile object control”) using the detection result signal output by the detection result output unit 34. Specifically, for example, in a case where the detection result signal indicates the sign of dozing “present”, the mobile object control unit 42 determines that it is necessary to execute the mobile object control. On the other hand, in a case where the detection result signal indicates the sign of dozing “absence”, the mobile object control unit 42 determines that it is not necessary to execute the mobile object control.

In a case where it is determined that it is necessary to execute the mobile object control, the mobile object control unit 42 executes the mobile object control. The mobile object control includes, for example, control of guiding the host vehicle to a road shoulder by operating the steering wheel in the host vehicle and control of stopping the host vehicle by operating the brakes in the host vehicle. Various known techniques can be used for the mobile object control. Detailed description of these techniques will be omitted.

Note that the driving assistance control unit 13 may include only one of the warning output control unit 41 and the mobile object control unit 42. That is, the driving assistance control unit 13 may execute only one of the warning output control and the mobile object control. For example, the driving assistance control unit 13 may include only the warning output control unit 41 out of the warning output control unit 41 and the mobile object control unit 42. That is, the driving assistance control unit 13 may execute only the warning output control out of the warning output control and the mobile object control.

Hereinafter, the functions of the information acquiring unit 11 may be collectively referred to as an “information acquiring function”. In addition, a reference sign “F1” may be used for such an information acquiring function. Furthermore, the processing executed by the information acquiring unit 11 may be collectively referred to as “information acquiring processing”.

Hereinafter, the functions of the sign detection unit 12 may be collectively referred to as a “sign detection function”. In addition, a reference sign “F2” may be used for such a sign detection function. Furthermore, the processing executed by the sign detection unit 12 may be collectively referred to as “sign detection processing”.

Hereinafter, the functions of the driving assistance control unit 13 may be collectively referred to as a “driving assistance function”. In addition, a reference sign “F3” may be used for such a driving assistance function. Furthermore, processing and control executed by the driving assistance control unit 13 may be collectively referred to as “driving assistance control”.

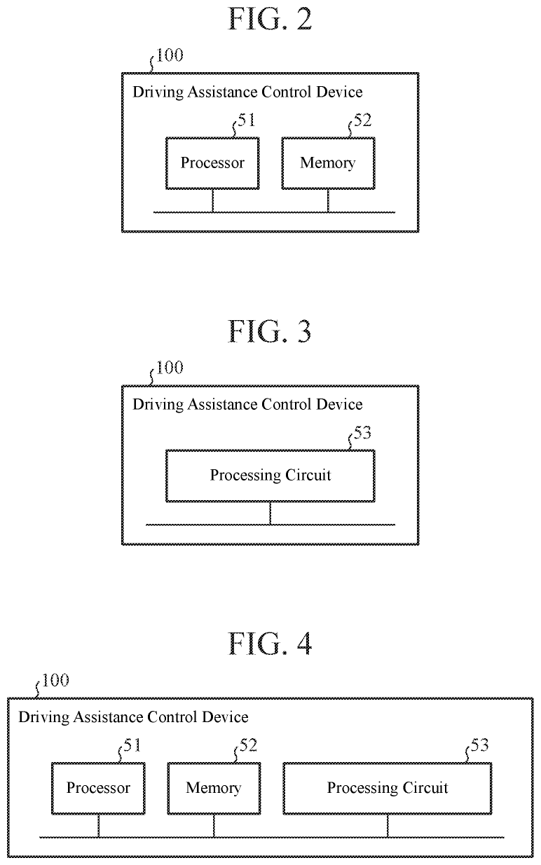

Next, a hardware configuration of a main part of the driving assistance control device 100 will be described with reference to FIGS. 2 to 4.

As illustrated in FIG. 2, the driving assistance control device 100 has a processor 51 and a memory 52. The memory 52 stores programs corresponding to the plurality of functions F1 to F3. The processor 51 reads and executes the program stored in the memory 52. As a result, the plurality of functions F1 to F3 are implemented.

Alternatively, as illustrated in FIG. 3, the driving assistance control device 100 includes a processing circuit 53. The processing circuit 53 executes processing corresponding to the plurality of functions F1 to F3. As a result, the plurality of functions F1 to F3 are implemented.

Alternatively, as illustrated in FIG. 4, the driving assistance control device 100 has a processor 51, a memory 52, and a processing circuit 53. The memory 52 stores programs corresponding to a part of the plurality of functions F1 to F3. The processor 51 reads and executes the program stored in the memory 52. As a result, such a part of functions is implemented. In addition, the processing circuit 53 executes processing corresponding to the remaining functions among the plurality of functions F1 to F3. As a result, the remaining functions are implemented.

The processor 51 includes one or more processors. Each processor is composed of, for example, a Central Processing Unit (CPU), a Graphics Processing Unit (GPU), a microprocessor, a microcontroller, or a Digital Signal Processor (DSP).

The memory 52 includes one or more nonvolatile memories. Alternatively, the memory 52 includes one or more nonvolatile memories and one or more volatile memories. That is, the memory 52 includes one or more memories. Each of the memories uses, for example, a semiconductor memory or a magnetic disk. More specifically, each of the volatile memories uses, for example, a Random Access Memory (RAM). In addition, each of the nonvolatile memories uses, for example, a Read. Only Memory (ROM), a flash memory, an Erasable Programmable Read Only Memory (EPROM), an Electrically Erasable Programmable Read Only Memory (EEPROM), a solid state drive, or a hard disk drive.

The processing circuit 53 includes one or more digital circuits. Alternatively, the processing circuit 53 includes one or more digital circuits and one or more analog circuits. That is, the processing circuit 53 includes one or more processing circuits. Each of the processing circuits uses, for example, an Application Specific Integrated Circuit (ASIC), a Programmable Logic Device (PLD), a Field Programmable Gate Array (FPGA), a System on a Chip (SoC), or a system Large Scale Integration (LSI).

Here, when the processor 51 includes a plurality of processors, the correspondence relationship between the plurality of functions F1 to F3 and the plurality of processors is arbitrary. That is, each of the plurality of processors may read and execute a program corresponding to one or more corresponding functions among the plurality of functions F1 to F3.

Further, when the memory 52 includes a plurality of memories, the correspondence relationship between the plurality of functions F1 to F3 and the plurality of memories is arbitrary. That is, each of the plurality of memories may store a program corresponding to one or more corresponding functions among the plurality of functions F1 to F3.

In addition, when the processing circuit 53 includes a plurality of processing circuits, the correspondence relationship between the plurality of functions F1 to F3 and the plurality of processing circuits is arbitrary. That is, each of the plurality of processing circuits may execute processing corresponding to one or more corresponding functions among the plurality of functions F1 to F3.

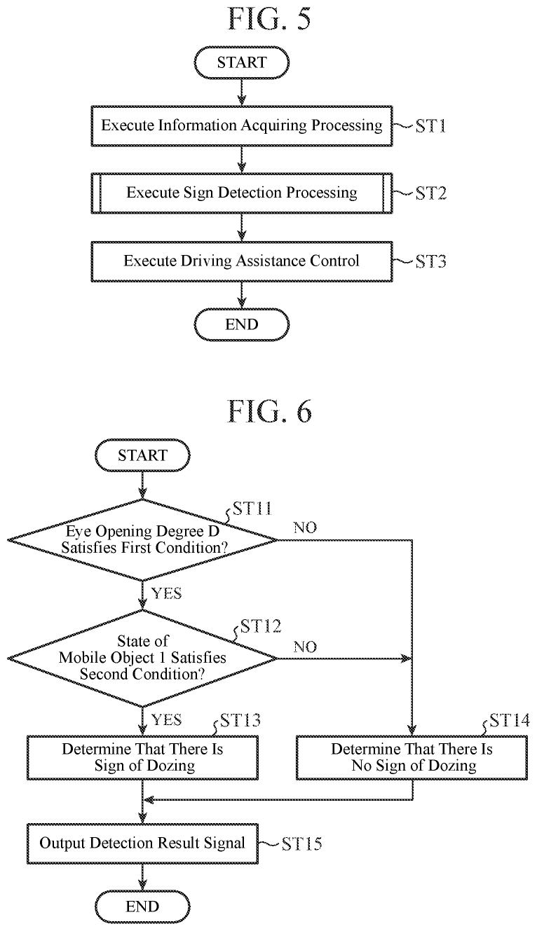

Next, the operation of the driving assistance control device 100 will be described with reference to the flowchart of FIG. 5.

First, the information acquiring unit 11 executes information acquiring processing (step ST1). As a result, the driver information, the surrounding information, and the mobile object information for the latest predetermined time T are acquired. From the viewpoint of implementing the determination in the second determination unit 32, T is preferably set to a value larger than the maximum value among T1, T2, T3, and T4. The processing of step ST1 is repeatedly executed when a predetermined condition is satisfied (for example, when an ignition power source in the host vehicle is turned on).

When the processing of step ST1 is executed, the sign detection unit 12 executes sign detection processing (step ST2). As a result, a sign of the driver dozing off in the mobile object 1 is detected. In other words, the presence or absence of such a sign is determined. For the sign detection processing, the driver information, the surrounding information, and the mobile object information acquired in step ST1 are used. Note that, in a case where the driver information has not been acquired in step ST1 (that is, in a case where the first information acquiring unit 21 has failed to acquire the driver information), the execution of the processing of step ST2 may be canceled.

When the processing of step ST2 is executed, the driving assistance control unit 13 executes driving assistance control (step ST3). That is, the driving assistance control unit 13 determines the necessity of at least one of the warning output control and the mobile object control in accordance with the detection result in step ST2. The driving assistance control unit 13 executes at least one of the warning output control and the mobile object control in accordance with such a determination result.

Next, an operation of the sign detection unit 12 will be described with reference to a flowchart of FIG. 6. That is, the processing executed in step ST2 will be described.

First, the first determination unit 31 determines whether or not the eye opening degree D satisfies the first condition by using the eye opening degree information acquired in step ST1 (step ST11). Specifically, for example, the first determination unit 31 determines whether or not the eye opening degree D is a value less than the threshold Dth.

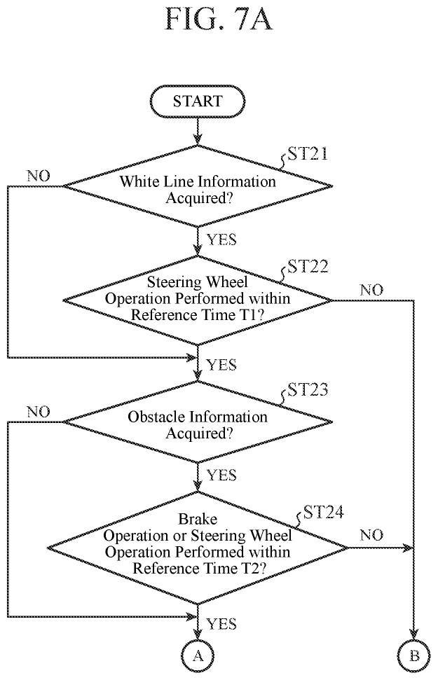

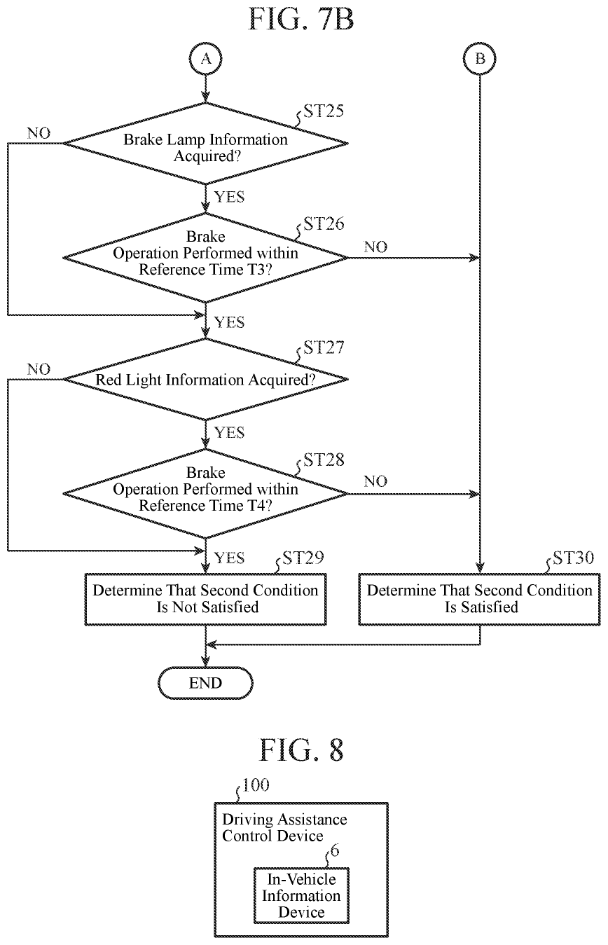

When it is determined that the eye opening degree D satisfies the first condition (step ST11 “YES”), the second determination unit 32 determines whether or not the state of the mobile object 1 satisfies the second condition using the surrounding information and the mobile object information acquired in step ST1 (step ST12). Details of the determination will be described later with reference to the flowchart of FIG. 7.

in a case where it is determined that the eye opening degree D satisfies the first condition (step ST11 “YES”), when it is determined that the state of the mobile object 1 satisfies the second condition (step ST12 “YES”), the third determination unit 33 determines that there is a sign of the driver dozing off in the mobile object 1 (step ST13). On the other hand, when it is determined that the eye opening degree D does not satisfy the first condition (step ST11 “NO”), or when it is determined that the state of the mobile object 1 does not satisfy the second condition (step ST12 “NO”), the third determination unit 33 determines that there is no sign of the driver dozing off in the mobile object 1 (step ST14).

Next, the detection result output unit 34 outputs a detection result signal (step ST15). That is, the detection result signal indicates the determination result in step ST13 or step ST14.

Next, the operation of the second determination unit 32 will be described with reference to the flowchart of FIG. 7. That is, the processing executed in step ST12 will be described.

When the white line information is acquired in step ST1 (step ST21 “YES”), the second determination unit 32 determines whether or not the corresponding steering wheel operation has been performed within the first reference time T1 by using the steering wheel operation information acquired in step ST1 (step ST22). When the corresponding steering wheel operation has not been performed within the first reference time T1 (step ST22 “NO”), the second determination unit 32 determines that the second condition is satisfied (step ST30).

When the obstacle information is acquired in step ST1 (step ST23 “YES”), the second determination unit 32 determines whether or not the corresponding brake operation or steering wheel operation has been performed within the second reference time T2 by using the brake operation information and the steering wheel operation information acquired in step ST1 (step ST24). When the corresponding brake operation or steering wheel operation has not been performed within the second reference time T2 (step ST24 “NO”), the second determination unit 32 determines that the second condition is satisfied (step ST30).

When the brake lamp information is acquired in step ST1 (step ST25 “YES”), the second determination unit 32 determines whether or not the corresponding brake operation has been performed within the third reference time T3 by using the brake operation information acquired in step ST1 (step ST26). When the corresponding brake operation has not been performed within the third reference time T3 (step ST26 “NO”), the second determination unit 32 determines that the second condition is satisfied (step ST30).

Further, when the red light information is acquired in step ST1 (step ST27 “YES”), the second determination unit 32 determines whether or not the corresponding brake operation has been performed within the fourth reference time T4 by using the brake operation information acquired in step ST1 (step ST28). When the corresponding brake operation has not been performed within the fourth reference time T4 (step ST28 “NO”), the second determination unit 32 determines that the second condition is satisfied (step ST30).

Otherwise, the second determination unit 32 determines that the second condition is not satisfied (step ST29).

Next, effects of the sign detection device 200 will be described.

First, by using the sign detection device 200, it is possible to detect a sign of the driver dozing off in the mobile object 1. As a result, the output of the warning or the control of the mobile object 1 can be implemented at the timing when the sign of dozing occurs before the occurrence of the dozing state.

Second, by using the sign detection device 200, it is possible to achieve detection of a sign of dozing at lows cost.

That is, the sign detection device 200 uses the first camera 2, the second camera 3, and the sensor unit 4 to detect a sign of dozing. Usually, the sensor unit 4 is mounted on the host vehicle in advance. On the other hand, the first camera 2 may be mounted on the host vehicle in advance or may not be mounted on the host vehicle in advance. In addition, the second camera 3 may be mounted on the host vehicle in advance or may not be mounted on the host vehicle in advance.

Therefore, when the sign detection device 200 is used to detect the sign of dozing, the hardware resources required to be added to the host vehicle are only zero cameras, one camera, or two cameras. As a result, the detection of the sign of dozing can be achieved at low cost.

Next, a modification of the driving assistance control device 100 will be described with reference to FIGS. 8 to 13. Further, a modification of the sign detection device 200 will be described with reference to FIG. 14.

An in-vehicle information device 6 may be mounted on the mobile object 1. The in-vehicle information device 6 includes, for example, an electronic control unit (ECU). In addition, a mobile information terminal 7 may be brought into the mobile object 1. The mobile information terminal 7 includes, for example, a smartphone.

The in-vehicle information device 6 and the mobile information terminal 7 may be communicable with each other. The in-vehicle information device 6 may be communicable with a server 8 provided outside the mobile object 1. The mobile information terminal 7 may be communicable with the server 8 provided outside the mobile object 1. That is, the server 8 may be communicable with at least one of the in-vehicle information device 6 and the mobile information terminal 7. As a result, the server 8 may be communicable with the mobile object 1.

Each of the plurality of functions F1 and F2 may be implemented by the in-vehicle information device 6, may be implemented by the mobile information terminal 7, may be implemented by the server 8, may be implemented by cooperation of the in-vehicle information device 6 and the mobile information terminal 7, may be implemented by cooperation of the in-vehicle information device 6 and the server 8, or may be implemented by cooperation of the mobile information terminal 7 and the server 8. In addition, the function F3 may be implemented by the in-vehicle information device 6, may be implemented by cooperation of the in-vehicle information device 6 and the mobile information terminal 7, or may be implemented by cooperation of the in-vehicle information device 6 and the server 8.

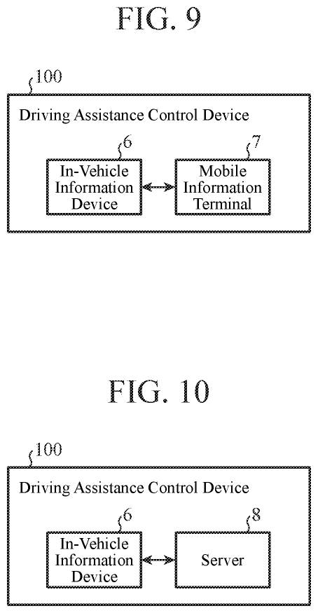

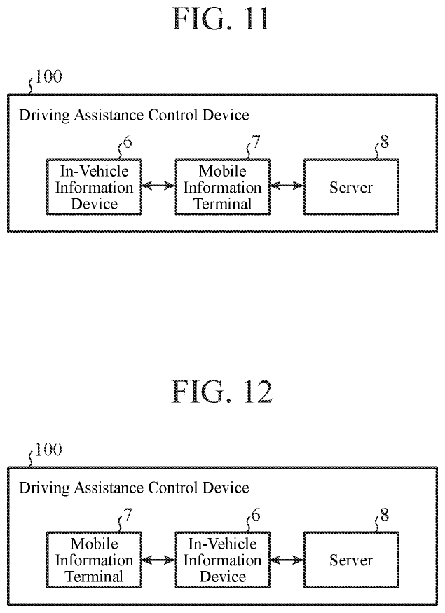

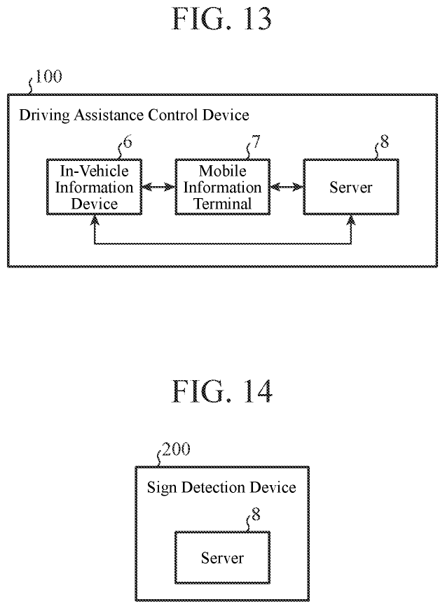

That is, as illustrated in FIG. 8, the in-vehicle information device 6 may constitute the main part of the driving assistance control device 100. Alternatively, as illustrated in FIG. 9, the in-vehicle information device 6 and the mobile information terminal 7 may constitute the main part of the driving assistance control device 100. Alternatively, as illustrated in FIG. 10, the in-vehicle information device 6 and the server 8 may constitute the main part of the driving assistance control device 100. Alternatively, as illustrated. in FIG. 11, FIG. 12, or FIG. 13, the in-vehicle information device 6, the mobile information terminal 7, and the server 8 may constitute the main part of the driving assistance control device 100.

In addition, as illustrated in FIG. 14, the server 8 may constitute the main part of the sign detection device 200. In this case, for example, when the server 8 receives the driver information, the surrounding information, and the mobile object information from the mobile object 1, the function F1 of the information acquiring unit 11 is implemented in the server 8. Furthermore, for example, when the server 8 transmits a detection result signal to the mobile object 1, notification of a detection result by the sign detection unit 12 is provided to the mobile object 1.

Next, another modification of the sign detection device 200 will be described.

The threshold Dth may include a plurality of thresholds Dth_1 and Dth_2. Here, the threshold Dth_1 may correspond to the upper limit value in a predetermined range R. In addition, the threshold Dth_2 may correspond to the lower limit value in the range R.

That is, the first condition may be based on the range R. Specifically, for example, the first condition may be set to a condition that the eye opening degree D is a value within the range R. Alternatively, for example, the first condition may be set to a condition that the eye opening degree D is a value outside the range R.

Next, another modification of the sign detection device 200 will be described.

In addition to acquiring the surrounding information, the second information acquiring unit 22 may acquire information (hereinafter, referred to as “brightness information”) indicating a brightness B in the surroundings with respect to the mobile object 1. Specifically, for example, the second information acquiring unit 22 detects the brightness B by detecting luminance in the second captured image. As a result, brightness information is acquired. Various known techniques can be used to detect the brightness B. Detailed description of these techniques will be omitted.

The first determination unit 31 may compare the brightness B with a predetermined reference value Bref by using the brightness information acquired by the second information acquiring unit 22. In a case where the brightness B indicated by the brightness information is a value greater than or equal to the reference value Bref, when the eye opening degree D indicated by the eye opening degree information is a value less than the threshold Dth, the first determination unit 31 may execute determination related to the first condition assuming that the eye opening degree D is a value greater than or equal to the threshold Dth. As a result, the occurrence of erroneous determination as described above can be further suppressed.

Next, another modification of the sign detection device 200 will be described.

The first condition is not limited to the above specific examples. The first condition may be based on the eye opening degree D for the latest predetermined time T5. In this case, T is preferably set to a value larger than the maximum value among T1, T2, T3, T4, and T5.

For example, the first condition may be set to a condition that the number of times N_1 exceeds a predetermined threshold Nth with respect to the number of times N_1 in which the eye opening degree D changes from a value equal to or greater than the threshold Dth to a value less than the threshold Dth within the predetermined time T5. Alternatively, for example, the first condition may be set to a condition that the number of times N_2 exceeds the threshold Nth with respect to the number of times N_2 in which the eye opening degree D changes from a value less than the threshold Dth to a value equal to or greater than the threshold Dth within the predetermined time T5. Alternatively, for example, the first condition may be set to a condition that the total value Nsum exceeds the threshold Nth with respect to the total value Nsum of the numbers of times N_1 and N_2.

That is, each of N_1, N_2, and Nsum corresponds to the number of times the driver of the mobile object 1 blinks his or her eyes within the predetermined time T5. By using the first condition based on the number of times, the sign of dozing can be detected more reliably.

Next, another modification of the sign detection device 200 will be described.

The second condition is not limited to the above specific examples. For example, the second condition may include at least one of a condition related to white line information and steering wheel operation information, a condition related to obstacle information, brake operation information, and steering wheel operation information, a condition related to brake lamp information and brake operation information, and a condition related to red light information and brake operation information.

In this case, information that is not used for the determination related to the second condition among the white line information, the obstacle information, the brake lamp information, and the red light information may be excluded from the acquisition target of the second information acquiring unit 22. In other words, the second information acquiring unit 22 may acquire at least one of the white line information, the obstacle information, the brake lamp information, and the red light information.

In addition, in this case, the information that is not used for the determination related to the second condition among the accelerator operation information, the brake operation information, and the steering wheel operation information may be excluded from the acquisition target of the third information acquiring unit 23. In other words, the third information acquiring unit 23 may acquire at least one of the accelerator operation information, the brake operation information, and the steering wheel operation information.

Next, another modification of the sign detection device 200 will be described.

The first condition may be set to, for example, a condition that the eye opening degree D exceeds the threshold Dth. In this case, in a case where it is determined that the first condition is not satisfied, when it is determined that the second condition is satisfied, the third determination unit 33 may determine that there is a sign of dozing.

For example, the second condition may be set to a condition that the operation (accelerator operation, brake operation, steering wheel operation, and the like) corresponding to the surrounding state (white line, obstacle, lighting of brake lamp, lighting of red signal, etc.) of the mobile object 1 is performed within the reference time (T1, T2, T3, or T4). In this case, in a case where it is determined that the first condition is satisfied, when it is determined that the second condition is not satisfied, the third determination unit 33 may determine that there is a sign of dozing.

In addition, the first condition and the second condition may be used in combination in the sign detection unit 12. In this case, in a case where it is determined that the first condition is not satisfied, when it is determined that the second condition is not satisfied, the third determination unit 33 may determine that there is a sign of dozing.

Next, another modification of the driving assistance control device 100 will be described.

The driving assistance control device 100 may include an abnormal state detection unit (not illustrated) in addition to the sign detection unit 12. The abnormal state detection unit determines whether or not the state of the driver of the mobile object 1 is an abnormal state by using the driver information acquired by the first information acquiring unit 21. As a result, the abnormal state detection unit detects an abnormal state. The driving assistance control unit 13 may execute at least one of warning output control and mobile object control in accordance with a detection result by the abnormal state detection unit.

The abnormal state includes, for example, a dozing state. For detection of the dozing state, eye opening degree information or the like is used. In addition, the abnormal state includes, for example, an inattentive state. For detection of the inattentive state, line-of-sight information or the like is used. In addition, the abnormal state includes, for example, a driving incapability state (so-called “dead man state”). For detection of the dead man state, face direction information or the like is used.

Various known techniques can be used to detect the abnormal state. Detailed description of these techniques will be omitted.

Here, in a case where the driving assistance control device 100 does not include the abnormal state detection unit, the first information acquiring unit 21 may not acquire the face direction information and the line-of-sight information. That is, the first information acquiring unit 21 may acquire only the eye opening degree information among the face direction information, the line-of-sight information, and the eye opening degree information.

As described above, the sign detection device 200 according to the first embodiment includes the information acquiring unit 11 to acquire the eye opening degree information indicating the eye opening degree D of the driver in the mobile object 1, the surrounding information indicating the surrounding state of the mobile object 1, and the mobile object information indicating the state of the mobile object 1, and the sign detection unit 12 to detect the sign of the driver dozing off by determining whether or not the eye opening degree D satisfies the first condition based on the threshold Dth and determining whether or not the state of the mobile object 1 satisfies the second condition corresponding to the surrounding state. As a result, it is possible to detect a sign of the driver dozing off in the mobile object 1.

In addition, the driving assistance control device 100 according to the first embodiment includes the sign detection device 200 and the driving assistance control unit 13 to execute at least one of control (warning output control) for outputting a warning in accordance with a detection result by the sign detection unit 12 and control (mobile object control) for operating the mobile object 1 in accordance with a detection result. As a result, the output of the warning or the control of the mobile object 1 can be implemented at the timing when the sign of dozing is detected before the occurrence of the dozing state.

In addition, the sign detection method according to the first embodiment includes the step ST1 in which the information acquiring unit 11 acquires the eye opening degree information indicating the eye opening degree D of the driver in the mobile object 1, the surrounding information indicating the surrounding state of the mobile object 1, and the mobile object information indicating the state of the mobile object 1, and the step ST2 in which the sign detection unit 12 detects the sign of the driver dozing off by determining whether or not the eye opening degree D satisfies the first condition based on the threshold Dth and determining whether or not the state of the mobile object 1 satisfies the second condition corresponding to the surrounding state. As a result, it is possible to detect a sign of the driver dozing off in the mobile object 1.

### Second Embodiment

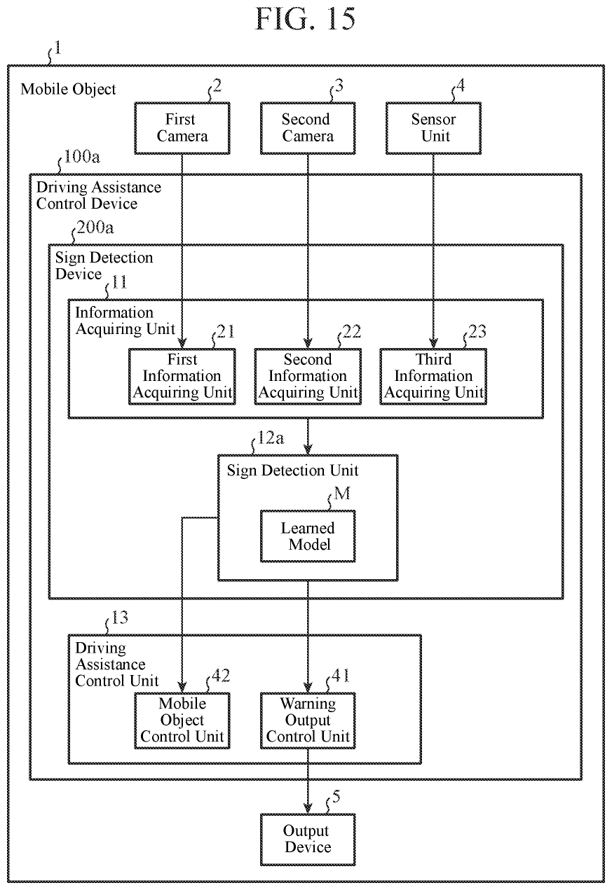

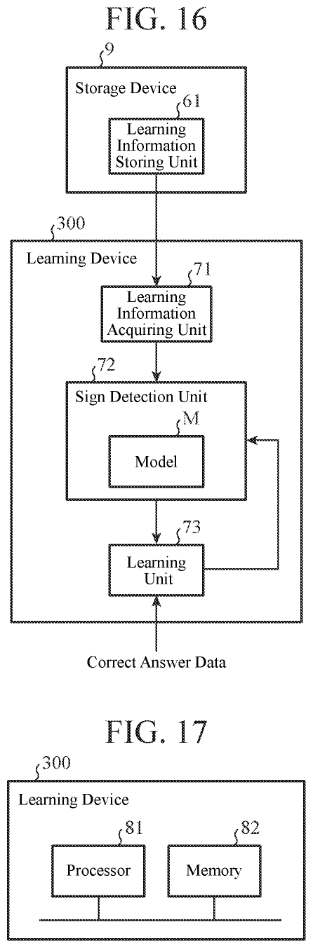

FIG. 15 is a block diagram illustrating a main part of a driving assistance control device including a sign detection device according to a second embodiment. FIG. 16 is a block diagram illustrating a main part of a learning device for the sign detection device according to the second embodiment. The driving assistance control device including the sign detection device according to the second embodiment will be described with reference to FIG. 15. Furthermore, a learning device for the sign detection device according to the second embodiment will be described with reference to FIG. 16. Note that, in FIG. 15, the same reference numerals are given to the same blocks as those illustrated in FIG. 1, and the description thereof will be omitted.

As illustrated in FIG. 15, the mobile object 1 includes a driving assistance control device 100a. The driving assistance control device 100a includes an information acquiring unit 11, a sign detection unit 12a, and a driving assistance control unit 13. The information acquiring unit 11 and the sign detection unit 12a constitute a main part of the sign detection device 200a.

The sign detection unit 12a detects a sign of the driver dozing off in the mobile object 1 by using the eye opening degree information acquired by the first information acquiring unit 21, the surrounding information acquired by the second information acquiring unit 22, and the mobile object information acquired by the third information acquiring unit 23.

Here, the sign detection unit 12a uses a learned model M by machine learning. The learned model M includes, for example, a neural network. The learned model M receives inputs of eye opening degree information, surrounding information, and mobile object information. In response to these inputs, the learned model M outputs a value (hereinafter, referred to as a “sign value”) P corresponding to a sign of the driver dozing off in the mobile object 1. The sign value P indicates, for example, the presence or absence of a sign of dozing.

In this manner, a sign of the driver dozing off in the mobile object 1 is detected. The sign detection unit 12a outputs a signal including the sign value P (that is, a detection result signal).

As illustrated in FIG. 16, a storage device 9 includes a learning information storing unit 61. The storage device 9 includes a memory. Furthermore, a learning device 300 includes a learning information acquiring unit 71, a sign detection unit 72, and a learning unit 73.

The learning information storing unit 61 stores information (hereinafter, referred to as “learning information”) used for learning of the model M in the sign detection unit 72. The learning information is, for example, collected using a mobile object similar to the mobile object 1.

That is, the learning information includes a plurality of data sets (hereinafter, referred to as a “learning data set”). Each of the learning data sets includes, for example, learning data corresponding to the eye opening degree information, learning data corresponding to the surrounding information, and learning data corresponding to the mobile object information. The learning data corresponding to the surrounding information includes, for example, at least one of learning data corresponding to white line information, learning data corresponding to obstacle information, learning data corresponding to brake lamp information, and learning data corresponding to red light information. The learning data corresponding to the mobile object information includes at least one of learning data corresponding to accelerator operation information, learning data corresponding to brake operation information, and learning data corresponding to steering wheel operation information.

The learning information acquiring unit 71 acquires learning information. More specifically, the learning information acquiring unit 71 acquires each of the learning data sets. Each of the learning data sets is acquired from the learning information storing unit 61.

The sign detection unit 72 is similar to the sign detection unit 12a. That is, the sign detection unit 72 includes a model M that can be learned by machine learning. The model M receives an input of the learning data set acquired by the learning information acquiring unit 71. The model M outputs the sign value P with respect to the input.

The learning unit 73 learns the model M by machine learning. Specifically, for example, the learning unit 73 learns the model M by supervised learning.

That is, the learning unit 73 acquires data (hereinafter, referred to as “correct answer data”) indicating a correct answer related to detection of the sign of dozing. More specifically, the learning unit 73 acquires correct answer data corresponding to the learning data set acquired by the learning information acquiring unit 71. In other words, the learning unit 73 acquires correct answer data corresponding to the learning data set used for detection of a sign by the sign detection unit 72.

Here, the correct answer data corresponding to each of the learning data sets includes a value (hereinafter, referred to as a “correct answer value”) C indicating a correct answer for the sign value P. The correct answer data corresponding to each of the learning data sets is, for example, collected at the same time when the learning information is collected. That is, the correct answer value C indicated by each of the correct answer data is set, for example, depending on the drowsiness felt by the driver when the corresponding learning data set is collected.

Next, the learning unit 73 compares the detection result by the sign detection unit 72 with the acquired correct answer data. That is, the learning unit 73 compares the sign value P output from the model M with the correct answer value C indicated by the acquired correct answer data. The learning unit 73 selects one or more parameters among the plurality of parameters in the model M in accordance with the comparison result and updates the value of the selected parameter. For example, in a case where the model M includes a neural network, each of the parameters corresponds to a weight value between layers in the neural network.

It is conceivable that the eye opening degree D has a correlation with the sign of dozing (refer to the description of the first condition in the first embodiment). Furthermore, it is conceivable that the correspondence relationship between the surrounding state of the mobile object 1 and the state of the operation of the mobile object 1 by the driver also has a correlation with the sign of dozing (refer to the description of the second condition in the first embodiment). Therefore, by executing learning by the learning unit 73 a plurality of times (that is, by sequentially executing learning using a plurality of learning data sets), the learned model M as described above is generated. That is, the learned model M that receives inputs of the eye opening degree information, the surrounding information, and the mobile object information and outputs the sign value P related to the sign of dozing is generated. The generated learned model M is used for the sign detection device 200a.

In addition, various known techniques related to supervised learning can be used for learning of the model M. Detailed description of these techniques will be omitted.

Hereinafter, the functions of the sign detection unit 12a may be collectively referred to as a “sign detection function”. Further, a reference sign “F2a” may be used for the sign detection function. In addition, the processing executed by the sign detection unit 12a may be collectively referred to as “sign detection processing”.

Hereinafter, the functions of the learning information acquiring unit 71 may be collectively referred to as “learning information acquiring function”. In addition, a reference sign “F11” may be used for the learning information acquiring function. Furthermore, the processing executed by the learning information acquiring unit 71 may be collectively referred to as “learning information acquiring processing”.

Hereinafter, the functions of the sign detection unit 72 may be collectively referred to as a “sign detection function”. Further, a reference sign “F12” may be used fur the sign detection function. In addition, the processing executed by the sign detection unit 72 may be collectively referred to as “sign detection processing”.

Hereinafter, the functions of the learning unit 73 may be collectively referred to as a “learning function”. Further, a reference sign “F13” may be used for the learning function. In addition, the processing executed by the learning unit 73 may be collectively referred to as “learning processing”.

The hardware configuration of the main part of the driving assistance control device 100a is similar to that described with reference to FIGS. 2 to 4 in the first embodiment. Therefore, detailed description is omitted. That is, the driving assistance control device 100a has a plurality of functions F1, F2a, and F3. Each of the plurality of functions F1, F2a, and F3 may be implemented by the processor 51 and the memory 52, or may be implemented by the processing circuit 53.

Next, a hardware configuration of the main part of the learning device 300 will be described with reference to FIGS. 17 to 19.

As illustrated in FIG. 17, the learning device 300 includes a processor 81 and a memory 82. The memory 82 stores programs corresponding to a plurality of functions F11 to F13. The processor 81 reads and executes the program stored in the memory 82. As a result, the plurality of functions F11 to F13 are implemented.

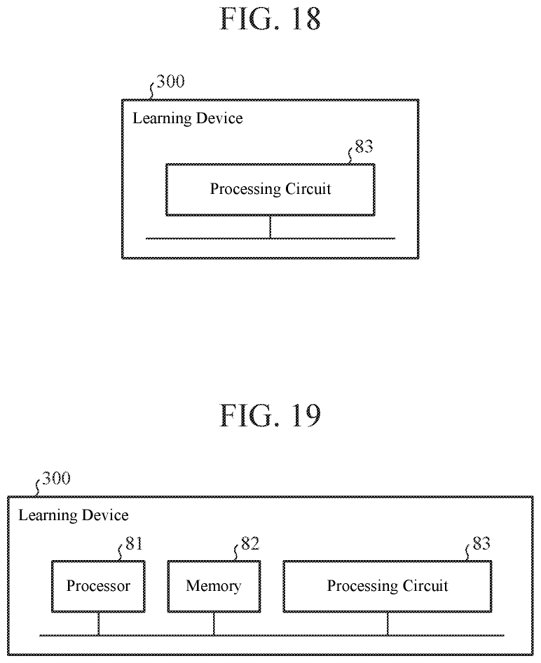

Alternatively, as illustrated in FIG. 18, the learning device 300 includes a processing circuit 83. The processing circuit 83 executes processing corresponding to the plurality of functions F11 to F13. As a result, the plurality of functions F11 to F13 are implemented.

Alternatively, as illustrated in FIG. 19, the learning device 300 includes the processor 81, the memory 82, and the processing circuit 83. The memory 82 stores programs corresponding to a part of the plurality of functions F11 to F13. The processor 81 reads and executes the program stored in the memory 82. As a result, such a part of functions are implemented. In addition, the processing circuit 83 executes processing corresponding to the remaining functions among the plurality of functions F11 to F13. As a result, the remaining functions are implemented.

A specific example of the processor 81 is similar to the specific example of the processor 51. A specific example of the memory 82 is similar to the specific example of the memory 52. A specific example of the processing circuit 83 is similar to the specific example of the processing circuit 53. Detailed description of these specific examples is omitted.

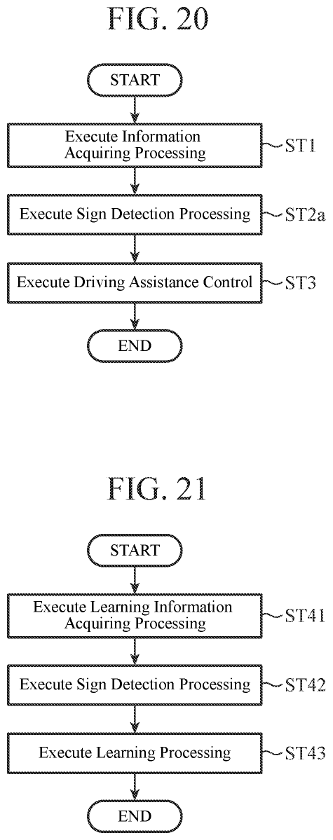

Next, the operation of the driving assistance control device 100a will be described with reference to the flowchart of FIG. 20. Note that, in FIG. 20, steps similar to the steps illustrated in FIG. 5 are denoted by the same reference numerals, and description thereof is omitted.

When the processing of step ST1 is executed, the sign detection unit 12a executes sign detection processing (step ST2a). That is, the eye opening degree information, the surrounding information, and the mobile object information acquired in step ST1 are input to the learned model M, and the learned model M outputs the sign value P. When the processing of step ST2a is executed, the processing of step ST3 is executed.

Next, the operation of the learning device 300 will be described with reference to the flowchart of FIG. 21.

First, the learning information acquiring unit 71 executes learning information acquiring processing (step ST41).

Next, the sign detection unit 72 executes sign detection processing (step ST42). That is, the learning data set acquired in step ST41 is input to the model M, and the model M outputs the sign value P.

Next, the learning unit 73 executes learning processing (step ST43). That is, the learning unit 73 acquires correct answer data corresponding to the learning data set acquired in step ST1. The learning unit 73 compares the correct answer indicated by the acquired correct answer data with the detection result in step ST42. The learning unit 73 selects one or more parameters among the plurality of parameters in the model M in accordance with the comparison result and updates the value of the selected parameter.

Next, a modification of the sign detection device 200a will be described. Furthermore, a modification of the learning device 300 will be described.

The learning information may be prepared for each individual. Thus, the learning of the model M by the learning unit 73 may be executed for each individual. As a result, the learned model M corresponding to each individual is generated. That is, a plurality of learned models M are generated. The sign detection unit 12a may select a learned model M corresponding to the current driver of the mobile object 1 among the plurality of generated learned models M and use the selected learned model M.

The correspondence relationship between the eye opening degree D and the sign of dozing can be different for each individual. In addition, the correspondence relationship between the surrounding state of the mobile object 1 and the state of the operation of the mobile object 1 by the driver and the correspondence relationship between the surrounding state of the mobile object 1 and the sign of dozing can also be different for each individual. For this reason, by using the learned model M for each individual, the sign of dozing can be accurately detected regardless of such a difference.

Alternatively, the learning information may be prepared for each attribute of a person.

For example, the learning information may be prepared for each sex. Thus, the learning of the model M by the learning unit 73 may be executed for each gender. As a result, the learned model M corresponding to each sex is generated. That is, a plurality of learned models M are generated. The sign detection unit 12a may select a learned model M corresponding to the sex of the current driver of the mobile object 1 among the plurality of generated learned models M and use the selected learned model M.

Furthermore, for example, the learning information may be prepared for each age group. Thus, the learning of the model M by the learning unit 73 may be executed for each age group. As a result, the learned model M corresponding to each age group is generated. That is, a plurality of learned models M are generated. The sign detection unit 12a may select a learned model M corresponding to the age of the current driver of the mobile object 1 among the plurality of generated learned models M and use the selected learned model M.

The correspondence relationship between the eye opening degree D and the sign of dozing may differ depending on the attribute of the driver. In addition, the correspondence relationship between the surrounding state of the mobile object 1 and the state of the operation of the mobile object 1 by the driver and the correspondence relationship between the surrounding state of the mobile object 1 and the sign of dozing can also be different depending on the attribute of the driver. For this reason, by using the learned model M for each attribute, the sign of dozing can be accurately detected regardless of such a difference.

Next, another modification of the sign detection device 200a will be described. Furthermore, another modification of the learning device 300 will be described.

First, the surrounding information may not include obstacle information, brake lamp information, and red light information. The mobile object information may not include accelerator operation information and brake operation information. Each of learning data sets may not include learning data corresponding to these pieces of information. In other words, the surrounding information may include white line information, and the mobile object information may include steering wheel operation information. Each of learning data sots may include learning data corresponding to these pieces of information. That is, the correspondence relationship between the white line in the forward area and the steering wheel operation is considered to have a correlation with the sign of dozing (refer to the description related to the second condition in the first embodiment). Therefore, by using these pieces of information, it is possible to achieve detection of a sign of dozing.

Second, the surrounding information may not include white line information, brake lamp information, and red light information. The mobile object information may not include accelerator operation information. Each of learning data sets may not include learning data corresponding to these pieces of information. In other words, the surrounding information may include obstacle information, and the mobile object information may include brake operation information and steering wheel operation information. Each of learning data sets may include learning data corresponding to these pieces of information. That is, the correspondence relationship between the obstacle in the forward area and the brake operation or the steering wheel operation is considered to have a correlation with the sign of dozing (refer to the description related to the second condition in the first embodiment). Therefore, by using these pieces of information, it is possible to achieve detection of a sign of dozing.

Third, the surrounding information may not include white line information, obstacle information, and red light information. The mobile object information may not include accelerator operation information and steering wheel operation information. Each of learning data sets may not include learning data corresponding to these pieces of information. In other words, the surrounding information may include brake lamp information, and the mobile object information may include brake operation information. Each of learning data sets may include learning data corresponding to these pieces of information. That is, the correspondence relationship between lighting of brake lamp of another vehicle in the forward area and brake operation is considered to have a correlation with the sign of dozing (refer to the description related to the second condition in the first embodiment). Therefore, by using these pieces of information, it is possible to achieve detection of a sign of dozing.

Fourth, the surrounding information may not include white line information, obstacle information, and brake lamp information. The mobile object information may not include accelerator operation information and steering wheel operation information. Each of learning data sets may not include learning data corresponding to these pieces of information. In other words, the surrounding information may include red light information, and the mobile object information may include brake operation information. Each of learning data sets may include learning data corresponding to these pieces of information. That is, the correspondence relationship between lighting of red light in the forward area and brake operation is considered to have a correlation with the sign of dozing (refer to the description related to the second condition in the first embodiment). Therefore, by using these pieces of information, it is possible to achieve detection of a sign of dozing.

Next, another modification of the sign detection device 200a will be described. Furthermore, another modification of the learning device 300 will be described.

The learned model M may receive input of eye opening degree information indicating the eye opening degree D for the latest predetermined time T5. In addition, each of learning data sets may include learning data corresponding to the eye opening degree information. Thus, learning and inference in consideration of the temporal change in the eye opening degree D can be implemented. As a result, detection accuracy by the sign detection unit 12a can be improved.

Furthermore, the second information acquiring unit 22 may acquire surrounding information and brightness information. The learned model M may receive inputs of the eye opening degree information, the surrounding information, the brightness information, and the mobile object information and output the sign value P. Each of learning data sets may include learning data corresponding to the eye opening degree information, learning data corresponding to the surrounding information, learning data corresponding to the brightness information, and learning data corresponding to the mobile object information. Thus, learning and inference in consideration of surrounding brightness can be implemented. As a result, detection accuracy by the sign detection unit 12a can be improved.

Next, a modification of the driving assistance control device 100a will be described. Furthermore, another modification of the sign detection device 200a will be described.

The driving assistance control device 100a can adopt various modifications similar to those described in the first embodiment. In addition, various modifications similar to those described in the first embodiment can be adopted for the sign detection device 200a.

For example, the in-vehicle information device 6 may constitute a main part of the driving assistance control device 100a. Alternatively, the in-vehicle information device 6 and the mobile information terminal 7 may constitute the main part of the driving assistance control device 100a. Alternatively, the in-vehicle information device 6 and the server 8 may constitute the main part of the driving assistance control device 100a. Alternatively, the in-vehicle information device 6, the mobile information terminal 7, and the server 8 may constitute the main part of the driving assistance control device 100a.

Furthermore, for example, the server 8 may constitute a main part of the sign detection device 200a. In this case, for example, when the server 8 receives the driver information, the surrounding information, and the mobile object information from the mobile object 1, the function F1 of the information acquiring unit 11 is implemented in the server 8. Furthermore, for example, when the server 8 transmits a detection result signal to the mobile object 1, notification of a detection result by the sign detection unit 12a is provided to the mobile object 1.

Next, another modification of the learning device 300 will be described.

The learning of the model M by the learning unit 73 is not limited to supervised learning. For example, the learning unit 73 may learn the model M by unsupervised learning. Alternatively, for example, the learning unit 73 may learn the model M by reinforcement learning.

Next, another modification of the sign detection device 200a will be described.

The sign detection device 200a may include the learning unit 73. That is, the sign detection unit 12a may have a model M that can he learned by machine learning. The learning unit 73 in the sign detection device 200a may learn the model M in the sign detection unit 12a using the information (for example, eye opening degree information, surrounding information, and mobile object information) acquired by the information acquiring unit 11 as the learning information.

As described above, the sign detection device 200a according to the second embodiment includes the information acquiring unit 11 to acquire the eye opening degree information indicating the eye opening degree D of the driver in the mobile object 1, the surrounding information indicating the surrounding state of the mobile object 1, and the mobile object information indicating the state of the mobile object 1, and the sign detection unit 12a to detect a sign of the driver dozing off by using the eye opening degree information, the surrounding information, and the mobile object information. The sign detection unit 12a uses the learned model M by machine learning, and the learned model M receives inputs of the eye opening degree information, the surrounding information, and the mobile object information and outputs the sign value P corresponding to the sign. As a result, it is possible to detect a sign of the driver dozing off in the mobile object 1.

The driving assistance control device 100a according to the second embodiment includes the sign detection device 200a and the driving assistance control unit 13 to execute at least one of control (warning output control) for outputting a warning in accordance with a detection result by the sign detection unit 12a and control (mobile object control) for operating the mobile object 1 in accordance with a detection result. As a result, the output of the warning or the control of the mobile object 1 can be implemented at the timing when the sign of dozing is detected before the occurrence of the dozing state.

Note that, within the scope of the disclosure of the present application, the embodiments can be freely combined, any component in each embodiment can be modified, or any component in each embodiment can he omitted.

### INDUSTRIAL APPLICABILITY

The sign detection device and the sign detection method according to the present disclosure can be used for a driving assistance control device, for example. The driving assistance control device according to the present disclosure can be used for a vehicle, for example.

### REFERENCE SIGNS LIST

1: mobile object, 2: first camera, 3: second camera, 4: sensor unit, 5: output device, 6: in-vehicle information device, 7: mobile intbrmation terminal, 8: server, 9: storage device, 11: information acquiring unit, 12, 12a: sign detection unit, 13: driving assistance control unit, 21: first information acquiring unit, 22: second information acquiring unit, 23: third information acquiring unit, 31: first determination unit, 32: second determination unit, 33: third determination unit, 34: detection result output unit, 41: warning output control unit, 42: mobile object control unit, 51: processor, 52: memory, 53: processing circuit, 61: learning information storing unit, 71: learning information acquiring unit, 72: sign detection unit, 73: learning unit, 81: processor, 82: memory, 83: processing circuit, 100, 100a: driving assistance control device, 200, 200a: sign detection device, 300: learning device

1. A sign detection device, comprising:
processing circuitry configured to
acquire eye opening degree information indicating an eye opening degree of a driver in a mobile object, surrounding information indicating a surrounding state of the mobile object, and mobile object information indicating a state of the mobile object; and
detect a sign of the driver dozing off by determining whether the eye opening degree satisfies a first condition based on a threshold and by determining whether the state of the mobile object satisfies a second condition corresponding to the surrounding state.

2. The sign detection device according to claim 1,
wherein the processing circuitry determines whether the state of the mobile object satisfies the second condition when it is determined that the eye opening degree satisfies the first condition.

3. The sign detection device according to claim 2,
wherein the processing circuitry determines that there is the sign when it is determined that the state of the mobile object satisfies the second condition in a case where it is determined that the eye opening degree satisfies the first condition.

4. The sign detection device according to claim 1, wherein the mobile object is a vehicle.

5. The sign detection device according to claim 1,
wherein the mobile object information includes at least one of accelerator operation information indicating a state of accelerator operation in the mobile object, brake operation information indicating a state of brake operation in the mobile object, and steering wheel operation information indicating a state of steering wheel operation in the mobile object.

6. The sign detection device according to claim 5,
wherein the mobile object information includes the steering wheel operation information,
the surrounding information includes information indicating a white line of a road in a forward area, and
the second condition includes a condition that a steering wheel operation corresponding to the white line is not performed within a first reference time.

7. The sign detection device according to claim 5,
wherein the mobile object information includes the brake operation information and the steering wheel operation information,
the surrounding information includes information indicating an obstacle in a forward area, and
the second condition includes a condition that a brake operation corresponding to the obstacle or a steering wheel operation corresponding to the obstacle is not performed within a second reference time.

8. The sign detection device according to claim 5,
wherein the mobile object information includes the brake operation information,
the surrounding information includes information indicating lighting of a brake lamp of another vehicle in a forward area, and
the second condition includes a condition that brake operation corresponding to the lighting of the brake lamp is not performed within a third reference time.

9. The sign detection device according to claim 5,
wherein the mobile object information includes the brake operation information,
the surrounding information includes information indicating lighting of a red light in a forward area, and
the second condition includes a condition that brake operation corresponding to the lighting of the red light is not performed within a fourth reference time.

10. The sign detection device according to claim 1,
wherein the first condition is set to a condition that the eye opening degree is below the threshold.

11. The sign detection device according to claim 1,
wherein the first condition is set to a condition based on at least one of the number of times the eye opening degree changes from a value equal to or greater than the threshold to a value less than the threshold within a predetermined time and the number of times the eye opening degree changes from a value less than the threshold to a value equal to or greater than the threshold within the predetermined time.

12. The sign detection device according to claim 10,
wherein the processing circuitry acquires brightness information indicating brightness in the surroundings, and
the processing circuitry regards the eye opening degree as a value equal to or greater than the threshold when the eye opening degree is a value less than the threshold in a case where the brightness is a value equal to or greater than a reference value.

13. The sign detection device according to claim 1,
wherein the sign detection device includes a server configured to freely communicate with the mobile object, and
the server notifies the mobile object of a detection result.

14. A driving assistance control device, comprising:
the sign detection device according to claim 1; and
a driving assistance controller to execute at least one of control for outputting a warning in accordance with the detection result and control for operating the mobile object in accordance with the detection result.

15. A sign detection method comprising:
acquiring eye opening degree information indicating an eye opening degree of a driver in a mobile object, surrounding information indicating a surrounding state of the mobile object, and mobile object information indicating a state of the mobile object; and
detecting a sign of the driver dozing off by determining whether the eye opening degree satisfies a first condition based on a threshold and by determining whether the state of the mobile object satisfies a second condition corresponding to the surrounding state.

16. A sign detection device, comprising:
processing circuitry configured to
acquire eye opening degree information indicating an eye opening degree of a driver in a mobile object, surrounding information indicating a surrounding state of the mobile object, and mobile object information indicating a state of the mobile object; and
detect a sign of the driver dozing off by using the eye opening degree information, the surrounding information, and the mobile object information, wherein
the processing circuitry uses a learned model by machine learning, and
the learned model receives inputs of the eye opening degree information, the surrounding information, and the mobile object information, and outputs a sign value corresponding to the sign.

17. The sign detection device according to claim 16, wherein the mobile object is a vehicle.

18. The sign detection device according to claim 16,
wherein the mobile object information includes at least one of accelerator operation information indicating a state of accelerator operation in the mobile object, brake operation information indicating a state of brake operation in the mobile object, and steering wheel operation information indicating a state of steering wheel operation in the mobile object.

19. The sign detection device according to claim 18,
wherein the mobile object information includes the steering wheel operation information, and
the surrounding information includes information indicating a white line of a road in a forward area.

20. The sign detection device according to claim 18,
wherein the mobile object information includes the brake operation information and the steering wheel operation information, and
the surrounding information includes information indicating an obstacle in a forward area.

21. The sign detection device according to claim 18,
wherein the mobile object information includes the brake operation information, and
the surrounding information includes information indicating lighting of a brake lamp of another vehicle in a forward area.

22. The sign detection device according to claim 18,
wherein the mobile object information includes the brake operation information, and
the surrounding information includes information indicating lighting of a red light in a forward area.

23. The sign detection device according to claim 16,
wherein the learned model receives an input of the eye opening degree information indicating the eye opening degree for a latest predetermined time.

24. The sign detection device according to claim 16,
wherein the processing circuitry acquires brightness information indicating surrounding brightness with respect to the mobile object, and
the learned model receives inputs of the eye opening degree information, the surrounding information, the brightness information, and the mobile object information, and outputs the sign value.

25. The sign detection device according to claim 16,
wherein the sign detection device includes a server configured to freely communicate with the mobile object, and
the server notifies the mobile object of a detection result.

26. A driving assistance control device comprising:
the sign detection device according to claim 16; and
a driving assistance controller to execute at least one of control for outputting a warning in accordance with the detection result and control for operating the mobile object in accordance with the detection result.
